(19) United States
(12) Patent Application Publication
(10) Pub. No.: US 2005/0139726 A1
(43) Pub. Date: Jun. 30, 2005

(54) Head wind against the transports converting into lift & air driven down force to save fuels & ecology

(76) Inventor: Yoshioki Tomoyasu, Fujisawa-shi (JP)

Correspondence Address: Yoshioki Tomoyasu, 21-22, Mirokuji 3-chome,, Fujisawa-shi, Kanagawa-ken, 251-0016, JP

(21) Appl. No.: 10/745,865

(22) Filed: Dec. 25, 2003

(51) Int. Cl. B64C 1/00

(52) U.S. Cl. 244/1 R

(57) ABSTRACT

The present invention is generally directed to converting the head wind against the transports such as vehicles 8, trains 13, aircrafts 20 and ships caused in the propellating operation into the lift force to lift the weight to save the consumption of the fuels and subsequently to reduce the exhausting gases, and the down air stream to press down the rear portion of the transports to stabilize for the driving operation by the combined use of both rudder 2 on the roof 4 and cover plate 1 over the roof 4 comprising the application of the hydraulic system 17 to the rudder 2 and the cover plate 1 to boost the lift in case where the driving force is less liable to produce the sufficient lift force. Furthermore, the invention covers the design to instal the device sharing the function of the rudder 2 to deflect the wind flow upward with a slant plate covered with the shock absorbing material 11 on the surface and sharing the safty function against the crush.

### FIELD OF THE INVENTION

The present invention is generally directed to the air dynamics on the transports entailed with fuel consumption as well as exhausting gases in propelling operation. The ecological situation over the world have been much affected with heavy loads such as the exhausting gases, much consumption of the petrochemical fuels and the nuclear power generating wastes and the like, thus required for the improving technology, in paticular, on the tranports.

### BACKGROUNG OF THE INVENTION

On the background that the transports such as vehicles, cruises, trains and airplanes are required for improving on the capability to reduce both exhausting gases and consuming fuels to keep the global ecology clean and sound, the new developments involved have been made remarkable progress in recent years especially in the industrial sector of the transport inclusive of which parts and devices such as filters with catalysis, light weight raw materials and high efficient engines, thus capable of attaining at the level required for clearing many restrictions imposed. However, further prevailing air contamination mainly caused by the petrochemical fuels is not allowed to be admitted in view of the proceeding pollution under the current situation. Thus, it is sought for quite different technological access apart from the conventional technology to prevent further introduction of the petrochemical fuels to the transports from being increased and rather to decrease the consumption to recover the global environment from the affection thereof.

### SUMMARY OF THE INVENTION

The present invention is directed to converting the head winf which reatrict the range of the transports such as vehicles, trains, ships and aircrafts caused in driving operation into the lift which serve to offer saving the heavy fuel consumption and subsequently reducing the exhausting gases at almost free of running costs by virtue of the combined use of the rudder equipped on the front roof and the cover plate over the roof thereof.

The rudder is capable of controlling over the lifting force by means of depending upon deflecting the mass of air flowing. On the assumption that the lift force is left to keep being at the mercy of the violent force on free conditions, the wind blow is liable to grow so strong that the transpot would be blown up into the air like a feather, thus being required to make arrangement for the control over the direction of the air flow by means of inclining in angle of the plate of the rudder. The mechanism of producing the lift is to convert the head wind into the air column pushing upwards the inside ceiling of the cover plate installed above the roof of the transport to be deflected by the rudder in driving operation. The lift is liable to act to lighten the weight subsequently to save fuel consumption and reduce exhausting gases. The column of the air flow directed upwards to produce the lift under the above mentioned cover plate is likely to revolve to convert into the down stream driven rearwards along the inclined inside ceiling to press down the rear section serving to stabilize for the driving operation. The cover bending downwards at the rear end prevent the attractive force pulling back caused by the voltex which is liable to be produced due to the pressure difference from giving rise to the rear end of the transport by means of taking the form of air guiding passage between the rear edge, thus allow to elimnate any possibility of providing the additional load entailed further loss of energy in driving operation.

The advantages on this invention available for the vehicle is to save the fuels and subsequently reduce the exhausting gases by virtue of the lift as well as the down stream. In case where this invention is adopted for the train, the speed up is attained by means of removing the heavy air pressure hung up ahead train. On application of this invention to the airplane, the conversion of the head wind into the lift force to be developed with the cover plate equipped above the airfoil allow to shorten the distance for taking off and landing in addition to making short for the length of the wings thereof under the same conditions, thus possible to save fuels and subsequently reducing exhausting gases. In technical as well as economical point of view, all the advantage avialable for the transports is attributable to the concept that this invention is directed to converting the load which ever have been abandoned or is intended to eliminate the waste effect under the same conditions into the useful energy. In every case of the application to the transports, it is possible to the hydraulic system to boost the lift by means of pushing small area of the front to the widely spread to the area of the cover in multiplying the force at the same ratio of areas involved. In case where the application of the devices involved to the transport, for instance the vehicles suffer from shortage of the wind force caused slow speed in driving operation, the introduction of the hydraulic system capable of augment the power of the lift in multiply the operating force of the rudder acting as a lever by dint of the wind force at the ratio of areas between the face of the hydraulic cylinder and that of the cover plate in contact with the fluid therein according to Pascal's theorem. The application of the hydraulic system to the aircrafts enalbe to shorten the distance for taking off and landing, moreover to make short for the length of the wingd. Another advantage of this invention is likely to provide the safety device to absorb the shock incurred by the crush at the traffic accident.

### BRIEF DESCRIPTIOM OF THE DRAWINGS

FIG. 1 is one of the example of the side view of the vehicle 8 equipped with the rudder 2 on or around the front roof 4 and with the cover plate 1 which is also installed over the roof 4 being inclined downwards to the tail rear end 3 over the rear edge 5 of the vehicle 8.

FIG. 2 is one of the example of the side view of the train applied with the cover plate 1 over the roof 4 inclining downwards to the rear end 3 and the rudder 2 installed on or around the roof 4 of the train 13.

FIG. 3 is one of the example of the side view of the aircraft 20 applied the hydraulic system 16 to augment the lift and the down force converted by the head wind against the nose 15 to operate the lever by the head wind respctively in flying operation.

FIG. 4 is one of the example of the side view of the ship 22 applied the hydraulic system 17 to be operated by the force of the wind force.

### DETAILED DESCRIPTION OF THE INVENTION

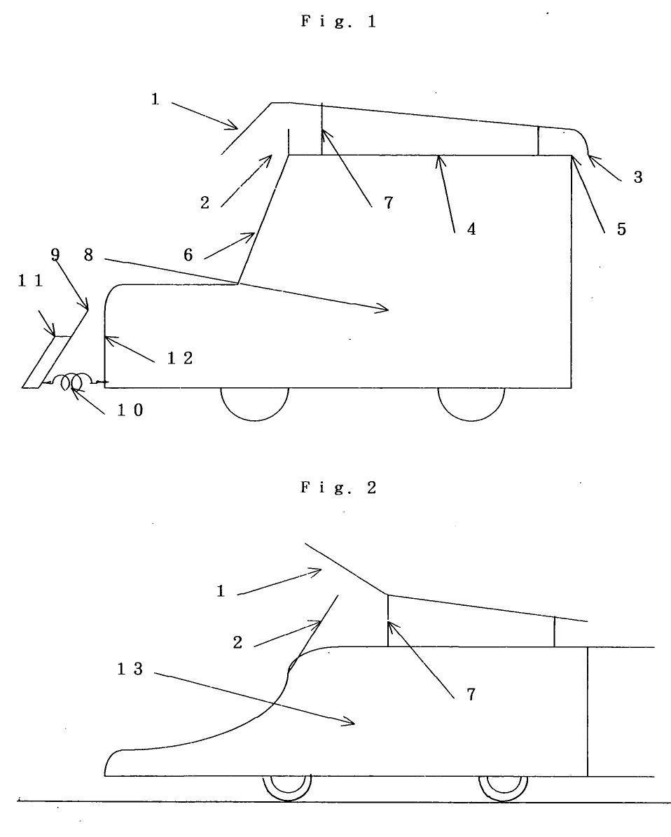

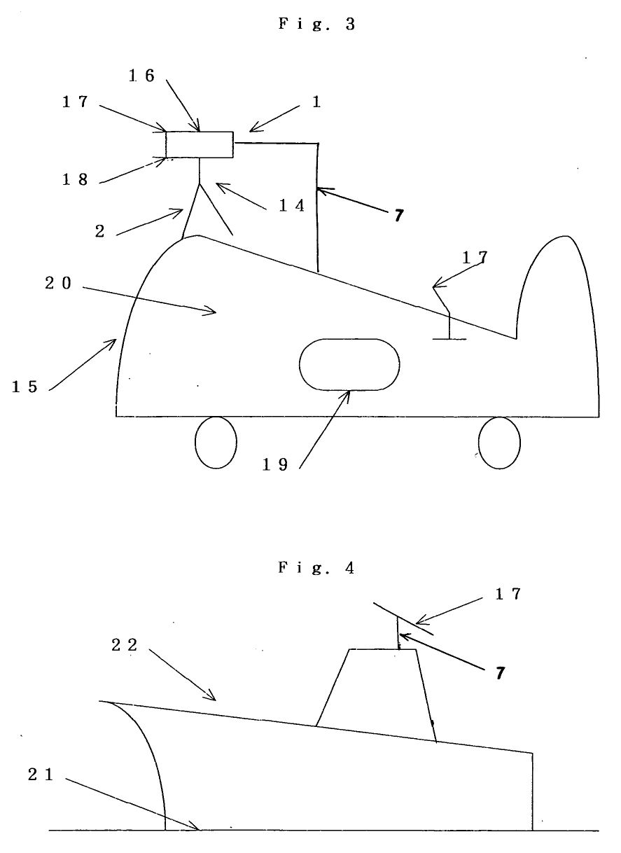

As shown in FIG. 1, the cover plate 1 of which rear end 3 is bent downwards is proped up with the support 7 between on and above the roof 4 of the vehicle 8, and the rudder 2 is installed on the roof 4 capable of being inclined to be in a preferable angle to direct the head wind against the front so as to reduce the drug to a minimum. Provided that the upper wall of the container loaded on the platform of the vehicle 8 appear to extrude over the roof 4, the rudder 2 is liable to take a form of a plate 1 in slant to make a triangle with the flat roof 4 and the perpendicular wall so that the head wind against the front area is likely to be pushed up to slide along the contour of its surface of the plate 1, thus the drag is reduced to small resistant as much as possible against the thrust force. The head wind against the vehicle 8 is likely to push up the cover plate 1 with the air column deflected by the rudder 2 inclined in the angle and revolve to be converted into the downstream pressing down the rear section of the roof 4, thus enabling to stabilize the driving operation. As far as the head wind blowing against the vehicle is concerned, it is required to be inclined at some portion or all over the inside ceiling of the cover plate 1, otherwise the air stream would appear to flow in parallel with the flat roof 4 in practice being less liable to develop neither lift nor downstream in view of the absense of the mechanism to deflect the air flow. It happens that the rear end 5 of the vehicle 8 is likely to produce the vortex entailed with the attractive force acting to pull back the body 8 caused by the pressure difference produced at the edge of the rear end 5, thus being augmented the consumption of the fuels and subsequently producing the exhausting gases. In order to avoid the load in the driving operation, the vehcles 8 are designed to take the form of smoothly bending down towards their rear end 5 where the vortex is incapable of being entirely eliminated, since the air flow at the rear edge 5 is entailed to produce the pressure difference. To counteract this, the trailing rear end 3 of the cover plate 1 is designed to extend its tail end 3 over the rear edge 5 as if the profile take the shape of the outlet of the air duct between the rear end 5 of the vehicle 8 thus reducing the pressure difference to a minimum to save the additional waste of energy as much as possible. The cover plate 1 must be proped up some pillars 7 on the roof 4 and the rudder 2 is applied to the front roof 4 in case of the vehicles 8. As shown in FIG. 2 with the express train 9, the too strong air pressure caused by the super high speed driving operation is made arrangement for the adequate air pressure by means of inclining the plate of the rudder 2 lest the excessive lift force should be developed toward the cover plate 1. On the other hand, the adequate lift force allow to remove the heavy air pressure laid on the front of the train enabling to accelerate the speed up corresponding to the reduced load and the lift over the train 2 serve to offer the reduction force on the weight and act to decrease the vibration caused by the friction between the iron wheel and railroad, thus being less liable to be transmitted to the passengers. As shown in FIG. 3, the application to the aircraft 20 allow to shorten the distance required for taking off and landing on developing the lift in addition to admitting the shorter length of the wings 19. As shown in FIG. 4, the application to the ship 22 is likely to provide stronger lift to serve to raise the water line to reduce the resistance against propelling power to a minimum. The friction loss incurred between the air flow and the surface of the rudder 2 in deflecting process remain to a small extent in view of the case of the delivery system of the make up air for the air conditioning in the building where many ducts are laid in inclined conditions enabling to transmit the air to all the corner of every floor smoothly. Whereas, the most reliable method to overcome the problem on the shortage of wind force in driving operation is to depend on introduction of the hydraulic system 17 to be operated by the wind force to augument the lift on the transport. The hydraulic system 17 applied to the transport to be operated by head wind to ensure to boost the lift to give the sufficient force in driving operation. The another advantage of this invention depends on the application to the vehicle 8 serving to offer the function to absorb the shock caused by the crush at the accident by dint of both cushion 11 and spring 10 equipped in front of the front 12 thereof. The other advantage of this invention is the application to the aircraft capable of shortening the distance at taking off and landing and the length of the wing 19. However, the main purpose of this invention is to save the consumption of the fuels, subsequently to eliminat exhausting gases to the great extent at the level that any restriction imposed on the pollution is cleared in comparatively small cost. Above all, the running cost is designed to be required to supplement almost nothing.

1. The method to save the fuels and to eliminate the exhausting gases and to stabilize the driving operation by means of converting the head wind against the tranports such as vehicles 8, trains 13, ships 18 and aircrafts 20 into the lift and the downward force in application of the rudder 2 on or around the roof 4 and the cover plate 1 over the roof 4 propped with pillars 7 based on or around the roof 4.

2. The above mentioned cover plate 1 which is installed over the roof 4 of the transport propped with the pillars 7 and which is inclined at some portion in order to serve to offer the function of capturing the deflected head wind with the inside ceiling of the cover plate 1 to produce the lift acting to reduce the weight of the body eventually to decrease the consumption of the fuels and the exhausting gases involved and moreover, to offer the additional function to revolve the wind blowing upward to turn the direction of the air stream down to press the rear portion of the transport enabling to stabilize the driving operation.

3. The above mentioned rudder 2 consisting of either plate or blades radiating outwards which is installed on or around the roof 4 of the transport to deflect the head wind upwards to push up the cover plate 1 to develop the lift. Alternatively, in case where either air pressure or hydraulic system 19 is applied to the cover plate 1 and the inside of the roof 4 where the fluid 11 is filled, the rudder 2 serve to offer the function of a lever to operate to be pushed by either air or hydraulic cylinder 12 directly or indirectly by dint of the wind pressure.

4. The design in the cross section of the tail end of the vehicle 8 composed of the rear end 3 of the cover plate 1 and the rear edge of the transport 5 take shape of outlet of a duct in propile to discharge the air current flow smoothly preventing from being impeded by the vortex to be produced by the pressure difference caused with sharp bending at the rear end.

5. In the design of the combined use of the rudder 2 on the roof 4 and the cover plate 1 over the roof 4 to convert the head wind against the vehicle 8 into the airlift, the front end of the cover plate 1 being either bent or inclined must be installed below the level of the position of the tip of the plate of the rudder 2 in order to allow to deflect the direction of the wind to blow upward where the side pressure is prevented from being provided by the strength of the wind blowing in side direction.

6. Either air pressure or hydraulic system 17 is introduced to the cover plate 1 and, if necessary, the roof 4 of the transports such as aircrafts 20, vehicles 8, ships 22 and the like with view to augmenting the power of the wind blow by the method that the plate of the rudder 2 on the roof 4 serve to offer the function of a lever to be operated by the wind force to press either hydraulic or air cylinder 18 into the fluid 16 filled in the cover plate 1 and, if necessary, in the inside of the roof 4 in the rearward section thereof.

7. The mechanism of either air pressure or hydraulic systems 17 applied to the cover plate 1 filled with fluid 16 of the air craft 20 where either air or hydraulic cylinder 18 is designed to operate when wind force blow to gear the function of the rudder 2 as a lever with view to boosting the lift force in flying operation.

8. The mechanism of either air pressure or hydraulic systems applied to the cover plate 1 filled with fluid 16 of either ship or yacht or boat where either air or hydraulic cylinder 18 is designed to operate when wind blow to gear the function of the rudder 2 as a lever with view to boosting the lift force to raise the water line to reduce the resistance to the cruising operation.

9. The lower rudder 9 consisting of a slant plate covered with the cushion material 11 such as rubber and plastic geared with the spring 10 in front of the front 12 of the vehicle 8 locating an air inlet is designed to serve to offer the function to deflect the direction of the head wind which is divided into two air flow, one wind passage is directed upward along the slant plate inclined in the angle and another wind flow is attracted to the air inlet of the front 12 of the vehicle 8 caused by pressure difference to be induced to cool down the radiator. On the other hand, another function of the lower rudder 9 is designed to allow to absorb the shock at the crush by the accident by the function of both cushon material 11 and the spring 10.

10. The design in application of the cover plate 1 and the rudder 2 to the speedy transport such as super express of train 13 where the tip of the rudder 2 is below position of that of the cover plate 1 shown in FIG. 2.
